(19) United States
(12) Patent Application Publication
(10) Pub. No.: US 2009/0172981 A1
(43) Pub. Date: Jul. 9, 2009

(54) Three-dimensional sign and method of making same

(76) Inventor: Victor J. Johannigman, Denver, CO (US)

Correspondence Address: VICTOR JOSEPH JOHANNIGMAN, 2962 E. MONTCLAIR CT., HIGHLANDS RANCH, CO, 80126, US

(21) Appl. No.: 12/082,270

(22) Filed: Jan. 4, 2008

(51) Int. Cl. G09F 13/00; G09F 7/00

(52) U.S. Cl. 40/541; 40/584; 29/525.01

(57) ABSTRACT

The present invention and associated process is generally related to three-dimensional signage. More specifically, one embodiment of the present invention includes a predetermined number of generally flat plates which are separated from each other and secured relative thereto, with a series of spacers and fasteners. This arrangement provides display in the third dimension that will more efficiently display a message to the consuming public. Further, the invention and associated process is adapted to receive a predetermined number of lights and/or mirrored surfaces to increase the advertising effect on the consuming public.

### FIELD OF THE INVENTION

The present invention relates generally to a sign that is adapted to display information in a three-dimensional manner.

### BACKGROUND OF THE INVENTION

Signs that display information in three-dimensions are well known. For example, some signs used as advertisements employ a combination of mirrors and lighting to portray information in three-dimensions. One drawback to signs of this nature is that they are often expensive to produce and are prone to damage, thus potentially increasing the lifetime cost to the sign owner. These signs are also not easily adapted to be scaled in size, wherein large billboards require larger mirrors, lights and power sources.

Often, especially in bars or sports venues, an advertiser desires to have their message brought to the public in a bold manner, which is usually accomplished with the addition of neon lights. The major drawback with neon lights is the power source needed to heat the neon gas that produces the light and the fragility of the tubes that contain the neon gas. More specifically, neon lights are extremely heavy, generate enormous amounts of heat and require a high degree of care when in use and during installation. These factors often cause neon lights to cost prohibitive for the average retailer seeking advertising.

Other three-dimensional signs exist that allow a vendor to boldly advertise their product or for government officials to highlight rules, such as street regulations. For example, some street signs are built in tiers, wherein a plurality of tiered shapes are stacked on top of each other to thus allow the sign to be seen from a side. The major drawback with this solid tier-type design is that as the sign becomes larger, its weight increases proportionately. In addition, these signs are often complicated to manufacture, wherein a plurality of fastening means are required to hold the layers of the sign together. Alternatively, a tiered sign may be created by machining, or otherwise carving, a solid block of material, such as aluminum for example, however, this machining process would necessarily increase the time to construct the sign and would thus increase costs.

The following disclosure describes a three-dimensional sign and a method of making the same, wherein the sign is of reduced weight, but yet adapted to display information boldly in a third dimension. In addition, the present invention is adapted to provide locations wherein additional lighting or mirrored surfaces may be interconnected, thus providing additional advertising options to the vendor.

### SUMMARY OF THE INVENTION

It is one aspect of the present invention to provide a sign that displays information in three-dimensions without lights or mirrors. More specifically, one embodiment of the present invention is constructed of a plurality of plates which are spaced a predetermined distance from each other. The plates maybe constructed of any rigid material such as aluminum, steel, wood, inconel, plastic, etc. The plates are designed to produce a three-dimensional shape, wherein the predetermined spacing results in a tiered, “wedding cake” effect that is lighter than the aforementioned solid signs. It is envisioned that one embodiment of the present invention employs shaped plates, wherein they produce a three-dimensional image of a logo, such as for the NFL, NCAA, NBA, MLB, PGA, NASCAR, etc., when tiered.

The plates are spaced apart by any means, such as blocks, spacers or fasteners. Preferably, one embodiment of the invention employs a plurality of “pem” fasteners and/or capacitive stud welds; which consist generally of a plate interface portion and a spacing portion, which is a cylindrical member that includes threads to receive a bolt-type fastener. More specifically, the “pem” fasteners and/or capacitive stud welds are adapted to interface through an aperture in the plate, wherein the interface portion is snugly fit into the plate, thus extending the spacing portion there from. Then an adjoining plate is selectively interfaced with the internally threaded cylinder, wherein a fastener is employed to hold the adjacent plate in place by interconnecting with the spacer. Thus, a tiered effect is created, wherein one plate is spaced a predetermined distance from it's neighboring plates.

As briefly mentioned above, the plates maybe shaped a number of ways to display the desired advertisement or team logo. For example, one embodiment of the present invention includes a base plate that includes a general outer shape. The next plate of this embodiment of the invention is a smaller version of the general outer shape, but has predetermined portions removed there from to display a portion of a team logo. The final plate includes a similar cutout of a team logo, such that when all three plates are combined, a complete logo with an insetted outline is produced. It will be appreciated by one skilled in the art that any combination of shaping of the plates maybe performed to accomplish the present invention. In addition, many different types of surface treatments maybe used, such as metal brushing, mirroring, painting, etc., to add color and/or surface effects to individual plates of the sign. It is also important to note that the base plate be provided with apertures or fastening means so that it may be easily interconnected to a display surface.

It is another aspect of the present invention to provide a sign that is adapted to receive lights. As mentioned briefly above, often a vendor will wish to more boldly display his or her wares. Often this is accomplished by the use of lights, often in the form of neon excited in tubes. The present invention is adapted to also be selectively illuminated, wherein the net effect will be a display, without the downside effects of using neon lighting. Preferably, one embodiment of the present invention employs plurality of fiber optic lights, which are interconnected to the underside of predetermined plates when viewed from the front. More specifically, the flexible fiber optic lights are interconnected to the rear surface of a plate, wherein illumination would reflect off the adjoining plate, thus hiding the light and illuminating a selected surface of the sign. One skilled in the art will appreciate that the present invention may also be equipped with mirrored surfaces to increase the reflectivity of the illumination. Alternatively, traditional neon lights or light bulbs, maybe added to the sign, wherein the necessary power sources and/or bulb interconnections are hidden from view to thus maintain the aesthetically pleasing sight of the sign.

Thus, it is one aspect of the present invention to provide a three-dimensional sign, which comprises:

a first surface with a perimeter edge defining a first shape having a plurality of apertures;

a second surface with a perimeter edge that defines a second shape having a plurality of apertures; and

a plurality of spacers positioned between said first surface and said second surface, wherein said first surface and said second surface are interconnected and spaced a predetermined distance from each other, thus producing a three dimensional, tiered visual effect. The Summary of the Invention is neither intended nor should it be construed as being representative of the full extent and scope of the present invention. The present invention is set forth in various levels of detail in the Summary of the Invention as well as in the attached drawings and the Detailed Description of the Invention and no limitation as to the scope of the present invention is intended by either the inclusion or non-inclusion of elements, components, etc., in this Summary of the Inventions.

### BRIEF DESCRIPTION OF THE DRAWINGS

The accompanying drawings, which are incorporated in and constitute a part of the specification, illustrate embodiments of the invention and together with the general Summary of the Invention given above and the Detailed Description of the drawings given below, serve to explain the principles of these embodiments.

FIG. 1 is a front elevation view of a three-dimensional sign of the present invention;

FIG. 2 is a left elevation view of the embodiment of the present invention shown in FIG. 1

FIG. 3 is a detail view of FIG. 2;

FIG. 4 is a front exploded view of the embodiment of the present invention shown in FIG. 1;

FIG. 5 is a detail view of the embodiment of the present invention shown in FIG. 1;

FIG. 6 is a front partial section view of the embodiment of the present invention shown in FIG. 1.

It should be understood that the drawings are not necessarily to scale. In certain instances, details which are not necessary for an understanding of the invention or which render other details difficult to perceive may have been omitted. It should be understood, of course, that the invention is not necessarily limited to the particular embodiments illustrated herein. To assist in the understanding of the present invention the following list of components and associated numbering found in the drawings is provided herein:

No. Component
2 Sign
6 Base plate
8 Middle plate
10 Front Plate
4 Fastener
14 Spacing portion
16 Fastening portion
18 Wall
26 Aperture
12 Consumer
20 Light source
22 Reflection
24 Mirrored surface
28 Upper portion of aperture
30 Fastener head
32 Plate contact area
34 Thru apertures

### DETAILED DESCRIPTION

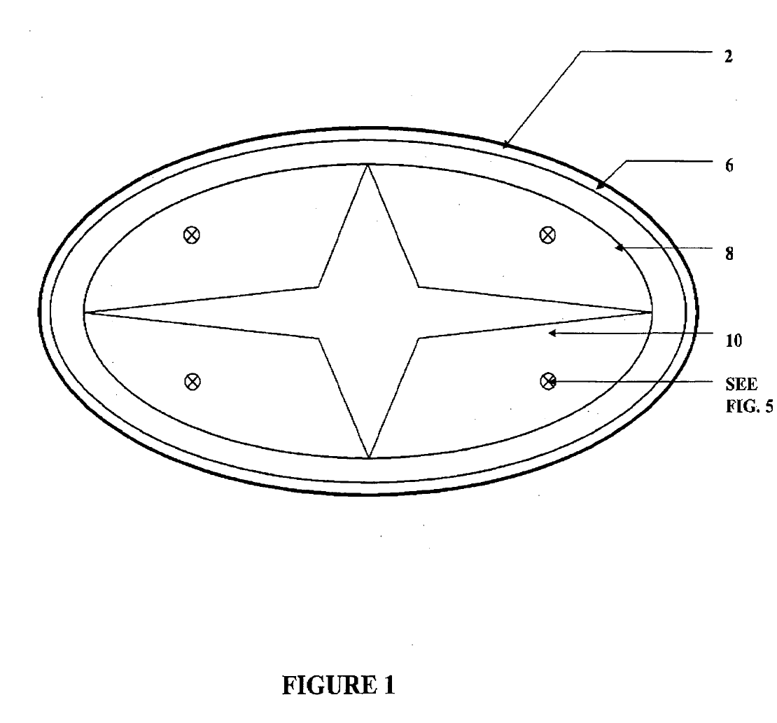

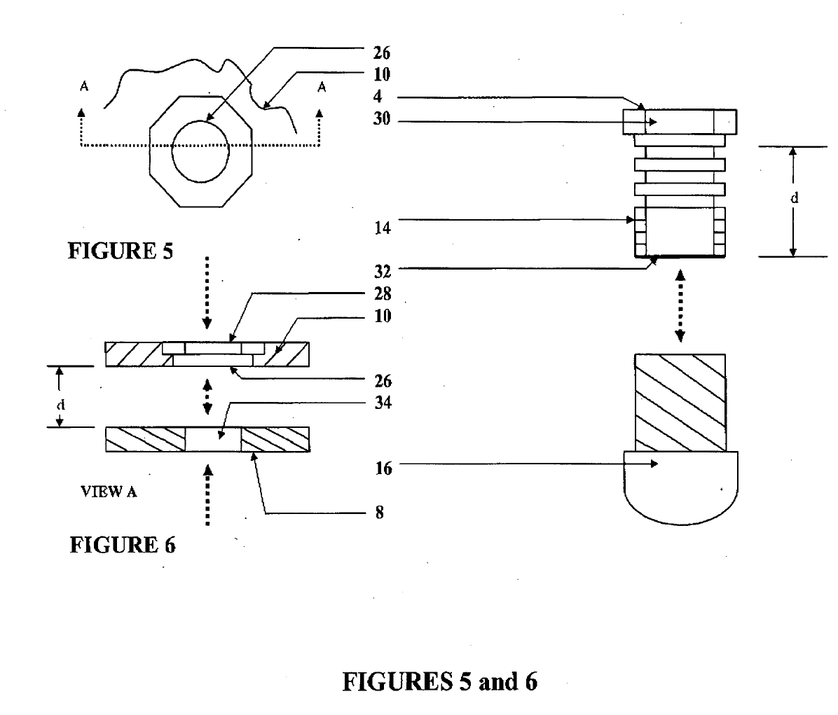

Referring now to FIGS. 1-6, a sign 2 of the present invention is shown herein. More specifically, one embodiment of the present invention is constructed of a plurality of plates that are separated from each other a predetermined distance by a plurality of fasteners 4. Each plate is shaped to form a portion of a logo, thereby creating a three-dimensional image when completed, such as the Colorado Crush® Arena Football Team logo.

Referring now to FIG. 1, a front view of the sign 2 is shown herein. One embodiment of the present invention is constructed of a plurality of plates, such as a base plate 6, a middle plate 8 and a front plate 10. As it will be appreciated by one of skill in the art, any number of plates maybe used to create a three-dimensional effect, depending on the complexity of the logo, colors, etc. As shown, the base plate 6 is generally oval-shaped which is undisturbed, that is, not machined to form a portion of a logo. However, one skilled in the art will appreciate that the base plate 6 may be constructed in any shape to fit any logo. In addition, the base plate 6 maybe painted or mirrored to produce a predetermined effect once completed. The middle plate 8 is constructed with a cutout of a portion of the logo, thereby selectively exposing the base plate when interconnected thereto. The front plate 10 is also machined such that the middle plate 8 acts as an outline of the finished symbol, wherein the colors of the front plate 10 act as a general background. It is easily appreciated by one skilled in the art that any number of plate shapes, colors or surface finishes maybe used to create any number of logos, advertisements, trademarks and/or images.

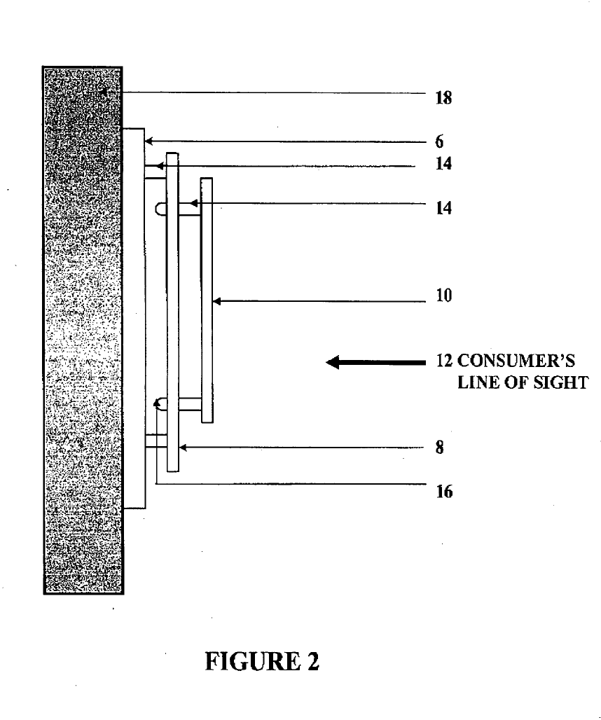

Referring now to FIG. 2, which shows a consumer 12 viewing the three-dimensional sign 2. When complete, the three-dimensional sign 2 is preferably a tiered assemblage, similar to a wedding cake, for example. This tiered effect is accomplished preferably with the use of “pem” fasteners and/or capacitive stud welds 16, wherein the spacing portion 14 provides-a predetermined distance between adjoinng plates. The fastening portion 16 of the “pem” fasteners and/or capacitive stud welds is then inserted through the adjoining plate to create a secure interconnection. The base plate 6 is interconnected to a wall 18 by either fasteners, welding, gluing, hooks, brackets, etc.

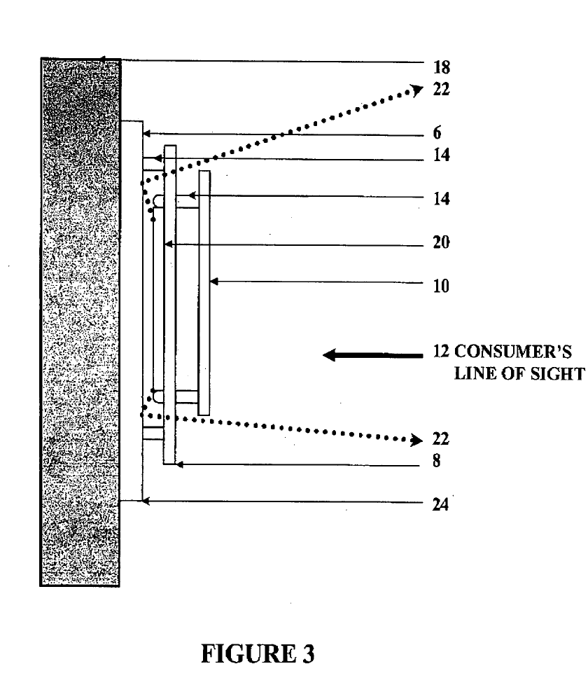

Referring now to FIG. 3, another embodiment of the present invention is shown, where lights 20 are integrated into the sign 2 for illumination. As shown herein, the light source 20, such as fiber optic light is added to the sign 2 behind one of the plates, thus obstructing the light from view. The illumination produced by the fight 20 is then selectively reflected 22 by the adjacent panel thus increasing the aesthetic value of the sign 2. Although fiber optic lights are shown and described herein, one skilled in the art will appreciate that other types of lights sources 20 such as neon light tubes or traditional light bulbs may be employed to produce the desired effects. In addition, to increase the reflectivity of the selective illumination, the surfaces of the plates may be adapted to reflect additional light or scatter it. For example, the surfaces maybe mirrored 24, painted, brushed or treated with light absorbent material. In addition, the surfaces may be treated with materials to make them glow in the dark or react differently to different types of light, such as black light.

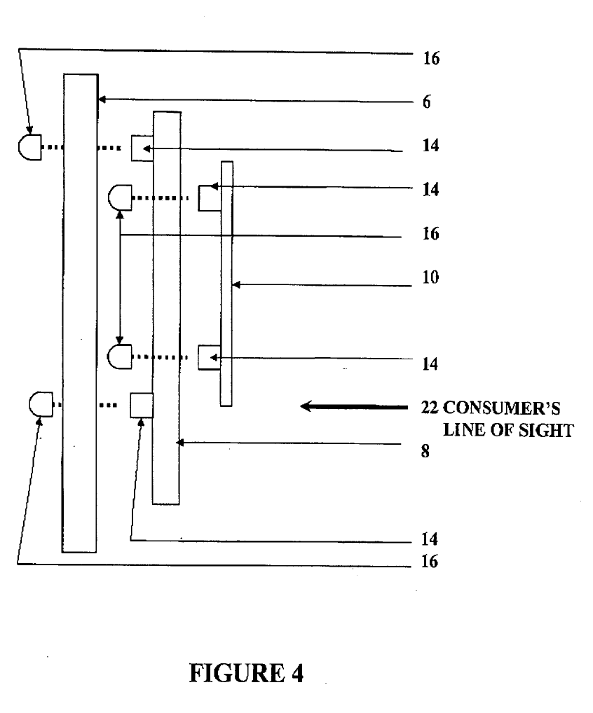

Referring now to FIGS. 4-6, the method of creating a three-dimensional sign 2 of the present invention is shown herein. More specifically, a plurality of plates are shown attached with “pem” fasteners and/or capacitive stud welds to create a tiered three-dimensional visual effect. Preferably, each plate is constructed with plurality of counter sunk apertures 26, wherein the upper portion of the aperture 28 is provided with the general parameter shape of a hexagonal-headed “pem” fastener and/or capacitive stud welds, such that the fastener's head 30 maybe seated tightly in the aperture and positioned flush with the plate. The spacing portion 14 of the fastener 4 extends through the plate, thereby providing a contact location 32 for the adjacent plate. Upon mating of the adjacent plate to the spacing portion of the “pem” fastener and/or capacitive stud weld, the fastening portion 16 of the “pem” fastener and/or capacitive stud welds system is inserted through another set of apertures 34 provided in the plates. The fastening portion 16 is then interconnected onto the inner threads of the spacing portion 14 of the “pem” fasteners and/or capacitive stud welds 4. Depending on the size and shape of the sign 2 in its finished state, any number of “pem” fasteners and/or capacitive stud welds 4 may be used to ensure the stability of the sign. It is important to note, that in one embodiment of the invention flat head fasteners are used on the base plate 6 of the sign 2, thereby providing a flush surface on which to mate the sign 2 to a flat surface, such as a wall.

While various embodiments of the present invention have been described in detail, it is apparent that modifications and adaptations of those embodiments will occur to those skilled in the art. However, it is to be expressly understood that such modifications and adaptations are within the scope and spirit of the present inventions, as set forth in the following claims.

What is claimed is:

1. A three dimensional sign adapted to display information or a logo, comprising;
a first surface with a perimeter edge defining a first shape having a varied number of apertures;
a second surface with a perimeter edge that defines a second shape having a varied number of apertures; and
an appropriate number of spacers positioned between said first surface and said second surface, wherein said first surface and said second surface are interconnected and spaced a predetermined distance from each other, thus producing a three-dimensional, tiered visual effect.

2. The three-dimensional sign of claim 1, wherein said spacers include an interconnecting means adapted to interconnect with said apertures of said second plate and a spacing portion extending from said interconnecting means that is adapted to interconnect with a fastener.

3. The three-dimensional sign of claim 1, wherein said first surface includes at least a portion thereof adapted to reflect light.

4. The dimensional sign of claim 1, further comprising a light source interconnected to said second surface which is adapted to selectively project light onto said first surface.

5. A method of constructing a three-dimensional sign that displays information or an image, comprising the steps of
providing a first plate with a first shape having a varying number of apertures;
providing a second plate with a second shape having a varying number of apertures, which is adapted to be spaced a predetermined distance from said first plate;
providing an appropriate number of spacing members, with a first end and a second end;
providing an appropriate number of fasteners;
interconnecting said first end of said spacing members into said apertures of said second plate;
interconnecting all of said fasteners to all of said spacing members, wherein said first plate is positioned there between and in contact with said second end of said spacing member and wherein a tiered visual effect is produced.

6. The method of claim 5, wherein said first plate or said second plate are a non-planar.

7. The method of claim 5, wherein said first shape and said second shape are such that upon said spacing a predetermined distance, said second plate generally overlaps said first plate and wherein selective portions of said first plate is exposed.

8. The method of claim 5, further comprising the step of adding a surface treatment of at least one of painting, sanding, brushing, coating and/or anodizing, to said first plate or said second plate.

9. The method of claim 5, further comprising providing a light source;
interconnecting said light source to said second plate, wherein light selectively illuminates said first plate.

10. The method of claim 9, wherein said light source is at least one of a fiber optic light, a neon light and/or a light bulb.

11. A three-dimensional sign produced by the steps of:
providing a first shape that includes a predetermined number of apertures;
providing a second plate with a second shape that includes a predetermined number of apertures, which is adapted to be spaced a a predetermined distance from said first plate;
providing a predetermined number of spacing members, with a first end and a second end;
providing a predetermined number of fasteners;
interconnecting said first end of said spacing members into said apertures of said second plate;
interconnecting all of said fasteners to all of said spacing members, wherein said first plate is positioned there between and in contact with said second end of said spacing member and wherein a tiered visual effect is produced.
